(19) United States
(12) Patent Application Publication
(10) Pub. No.: US 2010/0137128 A1
(43) Pub. Date: Jun. 3, 2010

(54) TITANIUM DIOXIDE LAYER WITH IMPROVED SURFACE PROPERTIES

(76) Inventors: Anett Berndt, Erlangen (DE); Florian Eder, Erlangen (DE); Rudolf Gensler, Singapore (SG); Heinrich Zeininger, Obermichelbach (DE)

Correspondence Address: King & Spalding LLP, 401 Congress Avenue, Suite 3200, Austin, TX, 78701, US

(21) Appl. No.: 12/527,770

(22) PCT Filed: Feb. 13, 2008
(86) PCT No.: PCT/EP08/51751

§ 371 Date: Jan. 25, 2010

(30) Foreign Application Priority Data
Feb. 19, 2007 (DE) 10 2007 008 121.0

(51) Int. Cl. B01J 21/06; C09C 1/36; C01G 23/047; B01J 21/02; B01J 31/02

(52) U.S. Cl. 502/150; 423/610; 502/350; 502/242; 502/351

(57) ABSTRACT

A thermocatalytically active titanium dioxide coating has a high BET surface area. With this coating, a catalytic effect can be achieved with only moderately increased temperatures (>200 DEG C.).

### CROSS-REFERENCE TO RELATED APPLICATIONS

This application is a U.S. National Stage Application of International Application No. PCT/EP2008/051751 filed Feb. 13, 2008, which designates the United States of America, and claims priority to German Application No. 10 2007 008 121.0 filed Feb. 19, 2007, the contents of which are hereby incorporated by reference in their entirety.

### TECHNICAL FIELD

The present invention relates to a thermocatalytically active titanium dioxide coating with a high BET surface area. Using this coating, a catalytic effect can be achieved with only moderately increased temperatures (>200° C.).

### BACKGROUND

In many applications related to motor vehicle and power plant technologies dirt precipitation (hydrocarbons, oils, dust, etc.) effectively affects the function of components such as sensors, injectors, valves, turbines or gas- and air compressors, for example.

It has therefore been proposed to provide such devices, which during operation are typically exposed to temperatures ranging from 200° C. to 600° C., with coatings having a thermally induced self-cleaning effect. In many cases it has to be accounted for that significant improvements with respect to reliability, durability, reduction of pollutant emissions and increasing efficiency can be achieved thereby.

However, it has become clear that the prior art coatings often are less adequate for the thermally induced decomposition of organic precipitation and only few such coatings are available at present.

A plurality of the prior art coatings utilized are based on metal oxides. For example, from DE 101 3067 3 vanadium pentoxide coatings for intake valves in internal combustion engines are known.

DE 199 153 77 describes a compound of transition metal oxides (manganese, cobalt, cerium) for deodorization.

Titanium dioxide is described as a photocatalytically effective material in D. Bahnemann “Photocatalytic water treatment—solar energy applications”, Solar Energy (2004), Vol. 77, p. 445-459.

In DE 10 2006 038 585.3 a titanium dioxide coating based on a sol-gel system is proposed.

However, the prior art coatings often comprise the disadvantage, that they are only catalytically effective at increased temperatures (for example above 300° C.) and/or the application of these layers comprises steps which have to be carried out at an increased temperature, so that a usage of these layers in applications based on glass or plastics, but also in applications based on metals potentially subjected to thermal conversions, is not always feasible.

### SUMMARY

According to various embodiments, a titanium dioxide coating can be provided which is able to overcome the above mentioned disadvantages at least partially and which in particular is catalytically effective already at lower temperatures in many applications.

According to an embodiment, a thermocatalytically active titanium dioxide coating may have a BET surface area of ≧10 m²/g to ≦250 m²/g.

According to a further embodiment, the titanium dioxide coating may have an activity of ≧0.001 at 250° C. According to a further embodiment, the titanium dioxide coating may have a temperature stability of ≧400° C. According to a further embodiment, the titanium dioxide coating may comprise areas in which the titanium dioxide substantially is comprised in titanium dioxide precursor particulates. According to a further embodiment, the titanium dioxide coating may comprise areas in which titanium dioxide precursor particulates are at least one of embedded in a binding agent matrix and are connected to each other by means of a binding agent. According to a further embodiment, the ratio of titanium dioxide versus binding agent may amount to ≧1:1 [Mol] to ≦3:1 [Mol]. According to a further embodiment, the binding agent can be selected from the group consisting of silicon and/or aluminum-oxidic and -organic compounds or compositions thereof. According to a further embodiment, the titanium dioxide precursor particulates may comprise surface active titanium dioxide precursor particulates, which have a BET surface area of ≧10 m²/g to ≦300 m²/g.

According to yet another embodiment, such a titanium dioxide coating as described above can be used for coating of at least one of: —sensors, —injectors, —valves, —turbines, —gas and air compressors, and —home appliances, in particular baking ovens and cookers.

### BRIEF DESCRIPTION OF THE DRAWINGS

Further details, features and advantages of the subject of the invention arise from the dependent claims as well as from the following description of the accompanying drawings, in which an exemplary embodiment of a titanium dioxide coating is shown by way of example. In the drawings:

FIG. 1 shows a scanning electron image of a double coated disk;

FIG. 2 shows a photograph of a disk for clarification of the thermocatalytical activity of a titanium dioxide coating according to Example 1;

FIG. 3 shows a diagram of a schematic apparatus for measuring the activity by means of IR spectrometric registration of the decomposition products (also see paragraph on method); and

FIG. 4 shows a diagram of an exemplary sample according to an embodiment as well as a comparative sample, the activity of which has been measured (also see paragraph on method).

### DETAILED DESCRIPTION

Accordingly, a thermocatalytically active titanium dioxide coating is provided, wherein the titanium dioxide coating has a BET surface area of ≧10 m²/g to ≦250 m²/g.

The term “titanium dioxide coating” in the context of the present invention in particular is to mean or encompasses that the coating comprises titanium dioxide as the main component and/or as the catalytically active main component. Preferably, >50%, more preferred >60% of the coating is of titanium dioxide.

In the context of the present invention the term “BET surface area” in particular is to mean or encompasses a specific surface area of a matter analyzed by means of gas sorption, wherein the amount of gas absorbed is proportional to the surface area.

A BET surface area may in particular be measured by means of a nitrogen sorption as is described as follows. By means of such a titanium dioxide coating according to various embodiments, one or more of the following advantages may be achieved in many applications within the scope of the present invention:
As compared to catalysts based on noble metal components the coating according to various embodiments is distinguished by a simple and material saving production and application, thereby avoiding complex processes such as vapor deposition (CVD/PVD).
A subsequent coating of large substrates (for example components of compressors in power plants) is in many cases feasible in situ.
The thickness of the titanium dioxide coating produced is not exceeding a few micrometers in many applications. It is therefore largely insensitive against thermal stress and only insignificantly affects device dimensions and tolerances.
By means of the usage of the titanium dioxide coating according to various embodiments a satisfying self cleaning effect may already be noticed in many applications with only moderately increased temperatures (from 200° C.).

An embodiment is characterized in that the titanium dioxide coating has a BET surface area of ≧40 m²/g to ≦220 m²/g, more preferred ≧60 m²/g to ≦180 m²/g, and most preferred ≧80 m²/g to ≦120 m²/g.

A further embodiment is characterized in that the titanium dioxide coating has an activity of ≧0.001 at 250° C., preferably of ≧0.001 to ≦1. This has been proven to be advantageous in many applications.

The term “activity” in the context of the present invention is to mean or encompasses in particular the ability of the coating to decompose organic materials into low molecular, volatile compounds (generally carbon dioxide) under increased temperature. The conversion rate, with which the decomposition of the organic impurity into carbon dioxide is effected, is referred to as activity.

As a reference value for an activity of 0.01 at 250° C. the following example may serve: a coating, for which in measurement methods described below an activity of 0.01 was determined, has the ability to decompose a selective impurity of lubricating grease (Shell Alvania RL3) of about 250 nl at a temperature of 250° C. in ambient air within 15 min virtually completely without remaining black or brownish discolorations.

An activity may be measured in particular by means of a IR spectrometric registration of the decomposition products as described in the following.

An embodiment is characterized in that the titanium dioxide coating has an activity of ≧0.01 at 250° C., preferably ≧0.1 to ≦0.8.

A further embodiment is characterized in that the titanium dioxide coating has a temperature stability of ≧400° C.

The term “temperature stability” in the context of the present invention in particular is to mean that at ≧400° C. (or at another selected temperature) the activity does not decrease or only decreases by ≦30 percent within 1 h, preferably within 2 h.

A further embodiment is characterized in that the titanium dioxide coating has a temperature stability of ≧450° C., more preferred of ≧500° C.

A further embodiment is characterized in that the titanium dioxide coating comprises areas in which the titanium dioxide substantially is enclosed in titanium dioxide particulates.

Preferably, these titanium dioxide particulates are present in crystalline modification, more preferred in anatase modification.

Here “substantially” is to mean and/or encompasses in particular ≧70%, more preferred ≧80%, and most preferred ≧90% to ≦100%. Preferably, all of the titanium dioxide is contained in the coating in the form of titanium dioxide particulates.

A further embodiment is characterized in that the titanium dioxide coating comprises areas in which titanium dioxide particulates are embedded in a binding agent matrix and/or are connected to each other by means of a binding agent.

A further embodiment is characterized in that the ratio of titanium dioxide versus the binding agent is from ≧1:1 to ≦3:1 [Mol/Mol].

A further embodiment is characterized in that the final binding agent is selected in its definite form from the group consisting of silicon and/or aluminum-oxidic and -organic compounds or compositions thereof.

A further embodiment is characterized in that the titanium dioxide particulates are composed of surface active titanium dioxide precursor particulates which have a BET surface area of ≧10 m²/g to ≦300 m²/g.

The term “composed of” herein is to mean and/or encompasses in particular that the surface active titanium dioxide precursor particulates are encased by binding agent and/or are embedded into a binding agent matrix during the production of the titanium dioxide coating.

A further embodiment is characterized in that the titanium dioxide precursor particulates have a medium particle size of ≧10 nm to ≦50 μm. This has been proven to be particularly beneficial for many applications within the scope of the present invention.

Preferably, the titanium dioxide precursor particulates have a medium particle size of ≧20 nm to ≦20 μm, more preferred of ≧30 nm to ≦10 μm.

A further embodiment is characterized in that the titanium dioxide coating may be produced by means of a sol-gel method in such a way, that titanium dioxide precursor particulates are embedded into a binding agent matrix by means of a sol-gel method.

The term “sol-gel method” in the context of the present invention is to mean or encompasses in particular all methods in which metal precursor materials, in particular metal halides and/or metal alkoxides are subjected to a hydrolysis in a diluted state and to a subsequent condensation.

According to yet another embodiment, the use of a titanium dioxide coating according to various embodiments and/or a titanium dioxide coating produced according to the above described method can be provided for
sensors,
injectors,
valves,
turbines,
gas and air compressors,
general purpose compressors
home appliances, in particular baking ovens and cookers

The components to be used according to various embodiments and as previously mentioned as well as claimed and described in the sample applications are not subjected to specific exceptions concerning their size, form, selection of material and technical design, so that the eligibility criteria known in the respective field of application may be applied without restrictions.

### Example 1

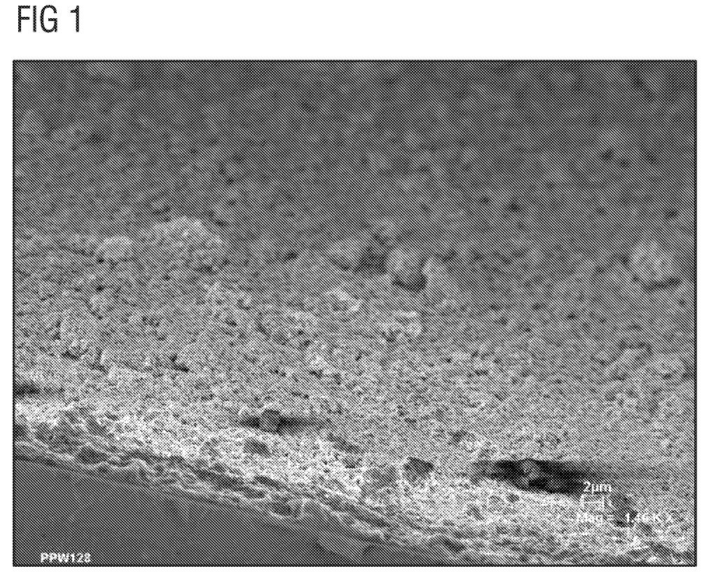

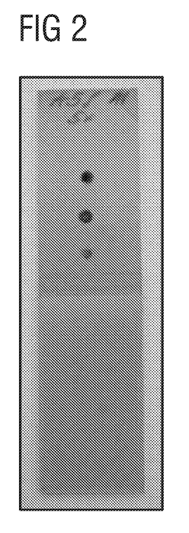

FIGS. 1 and 2 relate to the following Example 1, in which for illustrative purposes only and not to be limiting a titanium dioxide coating has been produced as follows:

At first a particle dispersion was produced by mixing 19.2 g of sopropanol and 0.384 g Byk 180 (dispersing agent) for 3 min. Subsequently, 2.2 g of titanium dioxide precursor particulates having a BET surface area of 90 m²/g were added and dispersed for 2 to 5 min using ultrasound.

Separately, a binding agent precursor mixture consisting of 3.8 g tetra ethoxyl silane which was mixed under stirring with 7.3 g of isopropyl alcohol and 1.5 ml of 1N HCl.

Subsequently, particle dispersion and binding agent precursor mixture were mixed. The titanium dioxide coating was applied by means of dip coating, subsequent drying, repeated dip coating and final drying.

FIG. 1 shows a scanning electron micrograph image of the titanium dioxide coating. Clearly, the high surface area of the sample determined to be 70 m²/g by means of nitrogen sorption can well be seen.

An activity measurement resulted in a value of 0.012.

FIG. 2 shows a photograph of a disk for clarification of the thermocatalytical activity of the titanium dioxide coating according to Example 1. The lower half of the disk was provided with the titanium dioxide coating, the upper half remains uncoated.

Three drops of 16.6% Shell Alvania test solution were applied to the upper and lower half, respectively, wherein the volumes were selected to be 100, 500 and 1500 nl.

Subsequently, the disk was stored for 10 min at 250° C. in an oven.

As can be seen clearly, no grease is visible anymore on the lower half; it had been decomposed free of residues. On the upper half, the carbonizations are clearly to be seen as residues.

### Methods:

### Bet Surface Area Measurement Method:

The BET surface area was measured according to S. Brunauer, P. Emmet, E. Teller, Absorption of Gases in Multimolecular Layers, J.A.C.S., Vol. 60, 1938, p. 309.

### Activity Measurement Method:

Activity was measured by means of an IR spectrometric registration of the decomposition products.

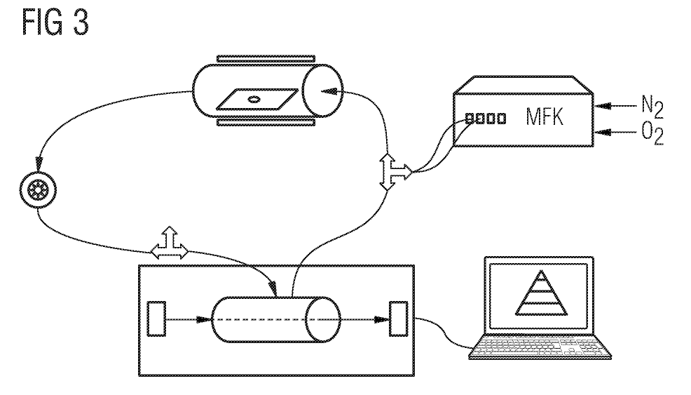

Depicted in FIG. 3 is the principle configuration of a usable apparatus. It is a matter of a closed circulation consisting of a heated reactor, in which the decomposition takes place on a coated test sample provided with an organic impurity and a gas cell mounted inside an IR spectrograph (trade name Bruker, Vector 22 with Opus 6) comprising CaF2 windows, which serves to measure the concentration of the decomposition products. This closed circulation is circulated by means of a membrane pump. Furthermore, it is feasible to fill the mass flow controller (trade name MIS) with a specific mixture of nitrogen and oxygen, which generally contains 78%/22% as in ambient air and above all is free of CO₂ impurities, so that a sufficiently exact measurement is feasible.

Characterization of a sample is conducted as follows: following the application of 1500 nl of 16.6% Shell Alvania test solution by means of a nanoliter pipette the sample is planted in the reactor after vaporization of the solvent (about 15 min), the circulation is locked airtight and is repeatedly evacuated by means of a pump and subsequently is again filled up to normal pressure using the above mentioned gas mixture, until no changes are to be measured concerning the measurement values for the CO₂ concentration, this is to mean that the CO₂ concentration in the circulation is below the resolution limit of the apparatus.

Subsequently, the reactor is heated up to 250° C., while at the same time the measurement is started. By means of the increased temperature the catalytically active coating is able to slowly decompose the grease impurities into CO₂, so that the CO₂ concentration steadily increases in the circulation over time. This is detected in the gas cell of the IR spectrograph and is put on record as a measurement value by means of a control computer each 1 to 4 min (depending on the activity of the sample). The measurement value results from an integration at the CO₂ bands of a surveyed spectrum. For this purpose, an adjustment/calibration curve was generated at the time of the initiation of the measurement system.

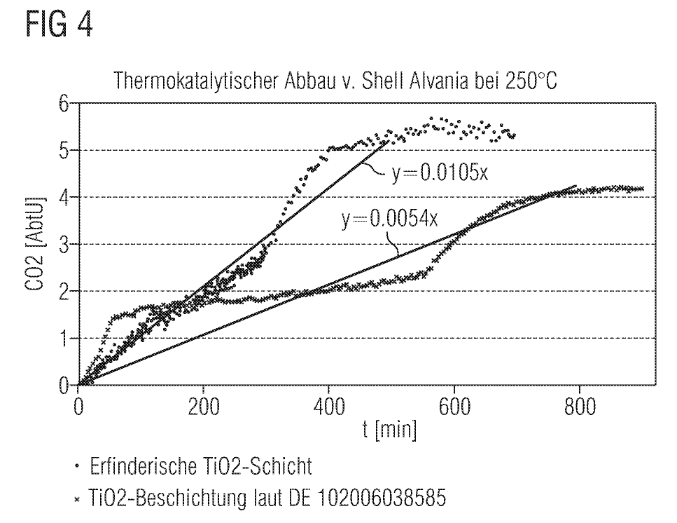

FIG. 4 shows a diagram of an exemplary sample according to an embodiment (upper plot) as well as of a comparative sample (lower plot). The comparative sample shows the activity of a layer according to DE 10 2006 0038585.

The measurement is carried out until the CO₂ value in the circulation system has reached a saturation level.

In the case of the exemplary sample shown in FIG. 4 this state is reached after about 5 hours. The increase of the CO₂ concentration in the system up to saturation (between about 30 and 300 min) is approximated by a straight line, the slope of which (here 0.0105) constitutes a quantity describing the catalytic activity of the sample.

The activity of the measured sample corresponding to the diagram of FIG. 4 therefore is 0.0105.

The activity of the comparative sample was found to be 0.0054.

What is claimed is:

1. A thermocatalytically active titanium dioxide coating, wherein the titanium dioxide coating has a BET surface area of ≧10 m²/g to ≦250 m²/g.

2. The titanium dioxide coating of according to claim 1, wherein the titanium dioxide coating has an activity of ≧0.001 at 250° C.

3. The titanium dioxide coating according to claim 1, wherein the titanium dioxide coating has a temperature stability of ≧400° C.

4. The titanium dioxide coating according to claim 1, wherein the titanium dioxide coating comprises areas in which the titanium dioxide substantially is comprised in titanium dioxide precursor particulates.

5. The titanium dioxide coating according to claim 1, wherein the titanium dioxide coating comprises areas in which titanium dioxide precursor particulates are at least one of embedded in a binding agent matrix and are connected to each other by means of a binding agent.

6. The titanium dioxide coating according to claim 1, wherein the ratio of titanium dioxide versus binding agent amounts to ≧1:1 [Mol] to ≦3:1 [Mol].

7. The titanium dioxide coating according to claim 1, wherein the binding agent is selected from the group consisting of silicon and/or aluminum-oxidic and -organic compounds or compositions thereof.

8. The titanium dioxide coating according to claim 1, wherein the titanium dioxide precursor particulates comprise surface active titanium dioxide precursor particulates, which have a BET surface area of ≧10 m²/g to ≦300 m²/g.

9. A method for coating, comprising the step of using a thermocatalytically active titanium dioxide coating, wherein the titanium dioxide coating has a BET surface area of ≧10 m²/g to ≦250 m²/g, for coating of at least one of
sensors,
injectors,
valves,
turbines,
gas and air compressors, and
home appliances.

10. The method according to claim 9, wherein the home appliance is a baking oven or a cooker.

11. The method according to claim 9, wherein the titanium dioxide coating has an activity of ≧0.001 at 250° C.

12. The method according to claim 9, wherein the titanium dioxide coating has a temperature stability of ≧400° C.

13. The method according to claim 9, wherein the titanium dioxide coating comprises areas in which the titanium dioxide substantially is comprised in titanium dioxide precursor particulates.

14. The method according to claim 9, wherein the titanium dioxide coating comprises areas in which titanium dioxide precursor particulates are at least one of embedded in a binding agent matrix and are connected to each other by means of a binding agent.

15. The method according to claim 9, wherein the ratio of titanium dioxide versus binding agent amounts to ≧1:1 [Mol] to ≦3:1 [Mol].

16. The method according to claim 9, wherein the binding agent is selected from the group consisting of silicon and/or aluminum-oxidic and -organic compounds or compositions thereof.

17. The method according to claim 9, wherein the titanium dioxide precursor particulates comprise surface active titanium dioxide precursor particulates, which have a BET surface area of ≧10 m²/g to ≦300 m²/g.
